(19) United States
(12) Patent Application Publication
(10) Pub. No.: US 2009/0268916 A1
(43) Pub. Date: Oct. 29, 2009

(54) FM TRANSMITTER

(75) Inventor: Hiroshi Miyagi, Tokyo (JP)

Correspondence Address: PATENTTM.US, P. O. BOX 82788, PORTLAND, OR, 97282-0788, US

(73) Assignees: NIIGATA SEIMITSU CO., LTD., Joestsu-shi, Niigata (JP); RICOH COMPANY, LTD., TOKYO (JP)

(21) Appl. No.: 12/067,164

(22) PCT Filed: Jun. 27, 2006
(86) PCT No.: PCT/JP2006/312766

§ 371 Date: Mar. 17, 2008

(30) Foreign Application Priority Data
Sep. 21, 2005 (JP) 2005-273060

(51) Int. Cl. H04H 20/48

(52) U.S. Cl. 381/3

(57) ABSTRACT

An FM transmitter improved in degree of freedom of selecting components. The FM transmitter comprises an oscillator 72 connected to a crystal oscillator 70, a clock generating circuit 50 for generating a clock signal having a frequency which is an integral multiple of the frequency of the output signal from the oscillator 72 by using the output signal as a reference frequency signal fr1, a DSP 20 operable synchronously with the clock signal and adapted for conducting digital stereo modulation, digital FM modulation, and digital IQ modulation of inputted stereo data, a frequency synthesizer 60 for generating a signal having a frequency which is an integral multiple of the frequency of the output signal from the oscillator 72 by using the output signal as a reference frequency signal fr2, mixers 40, 42 for mixing the signals outputted from the DSP 20 with the signal generated by the frequency synthesizer 60, an adder 44 for adding the outputs from the mixers 40, 42, and amplifier 46 for amplifying the output signal from the adder 44 to transmit it from an antenna 48.

### TECHNICAL FIELD

The present invention relates to an FM transmitter for converting an audio signal and the like to an FM signal and transmitting the same.

### BACKGROUND ART

Heretofore, an FM transmitter has been known which is capable of converting an audio signal to an FM signal for transmission and outputting a voice from an FM receiver installed at a nearby site (See Patent Document 1). This FM transmitter sets an oscillation frequency of a crystal oscillator to an integer multiple or integer fraction of 7.6 MHz, and by dividing this oscillation signal, a signal of 38 kHz necessary for an FM modulation processing and a reference frequency signal of 50 kHz necessary for a PLL circuit for FM broadcast wave output are generated. Thus, by dividing the oscillation signal of one crystal oscillator so as to generate signals of two types, the configuration is simplified as compared with the conventional FM transmitter provided with two crystal oscillators.

### Patent Document 1: Japanese Patent Laid-Open No. 2000-228635 (pp. 3-4, FIG. 1)

### DISCLOSURE OF THE INVENTION

Now, in the FM transmitter disclosed in Patent Document 1, there has been a problem in that since it is necessary to perform frequency dividing in order to generate the signals of 38 kHz and 50 kHz, the oscillation frequency of the crystal oscillator is extremely limited, and a problem has arisen in that there are few degrees of freedom in selecting components.

The present invention has been made in view of such problem, and an object of the invention is to provide an FM transmitter improved in the degree of freedom in selecting components.

To solve the problem, the FM transmitter of the present invention includes an oscillator connected with a crystal resonator, a clock generating circuit for generating a clock signal synchronized with an output signal of the oscillator, a digital signal processor inputted with the clock signal generated by the clock generating circuit as an operation clock and performing stereo modulation operation for stereo data by digital processing, and a carrier wave generating circuit directly inputted with the output signal of the oscillator and generating a carrier wave synchronizing with the output signal and of frequency of an integer multiple of frequency of the output signal, wherein an FM modulation signal frequency-modulated by a stereo composite signal obtained by stereo modulating the carrier wave performed by the digital signal processor is transmitted.

Each function of the oscillator except for the crystal resonator, the clock generating circuit, the digital signal processor, and the carrier wave generating circuit is preferably formed on a semiconductor substrate integrally by using a semiconductor process. By forming each function of all components except for the crystal resonator as one chip by the semiconductor process, the miniaturization of the FM transmitter, easiness of the manufacture, the reduction of power consumption, and the like become possible. Particularly, by adopting a CMOS process as the semiconductor process, the effects of these features become remarkable.

The clock generating circuit is a first PLL circuit inputted with the output signal of the oscillator as a first reference frequency signal fr1, and when a dividing ratio of a first frequency divider included in the first PLL circuit is taken as an integer m, a clock signal having a frequency m times the frequency of the first reference frequency signal fr1 is preferably generated. The carrier wave generating circuit is a second PLL circuit inputted with the output signal of the oscillator as a second reference frequency signal fr2, and when a diving ratio of a second frequency divider included in the second PLL circuit is taken as an integer n, a carrier wave having a frequency n times the frequency of the second reference frequency signal fr2 is preferably generated.

The digital signal processor, by using a so-called a DSP, can realize stereo modulation processing without actually generating a sub-carrier signal of 38 kHz and a pilot signal of 19 kHz, and this eliminates the necessity of using those having the natural vibration frequency of an integer multiple of 19 kHz and 38 kHz as the crystal resonator, and can improve the degree of freedom in selecting component parts.

The second PLL circuit is a frequency synthesizer in which the dividing ratio n of the second frequency divider can be varied, and is preferably further provided with a control section for variably setting the frequency of the output signal of the second PLL circuit at a frequency allocation interval of the FM broadcast wave or an integer fraction interval of the frequency allocation interval by changing the dividing ratio n. As a result, an FM modulation signal receivable in the ordinary FM receiver for receiving the FM broadcast wave can be transmitted. Further, since the frequency of the FM modulation signal can be changed over by the frequency allocation interval of the FM broadcast wave, a free frequency not receiving the FM broadcast wave in the FM receiver can be easily found out.

The carrier wave generating circuit preferably outputs a signal as a carrier wave in which the signal generated by the second PLL circuit is divided by a third frequency divider of a dividing ratio L. Particularly, the second PLL circuit is a frequency synthesizer in which the dividing ratio n of the second frequency divider can be changed, and is preferably further provided with a control section for variably setting the frequency of the output signal of the second PLL circuit at the frequency interval multiplied by the dividing ratio L of the third frequency divider for the frequency allocation interval of the FM broadcast wave or an interval of an integer fraction of the frequency allocation interval by changing the dividing ratio n. As a result, when the frequency interval of the generable carrier wave is constant, the frequency interval of the output signal of the second PLL circuit can be widened, and this enables the frequency condition of the crystal resonator used for generating the second reference frequency signal fr2 inputted to the second PLL circuit to be further alleviated.

The crystal resonator preferably has a natural vibration frequency unmatched with the frequency allocation interval of the FM broadcast wave or an integer fraction of the frequency allocation interval. As a result, the frequency condition required for the usable crystal resonator can be further alleviated, thereby to improve the degree of freedom in selecting the components.

Further, the crystal resonator preferably has a natural vibration frequency unmatched with the frequency allocation interval of the FM broadcast wave or an integer fraction of this frequency allocation interval, and moreover, unmatched with an integer multiple of 19 kHz. Alternatively, the crystal resonator preferably has the natural vibration frequency which does not match the frequency multiplied the dividing ratio L of the third frequency divider for the frequency allocation interval of the FM broadcast wave or an integer fraction of this frequency allocation interval, and moreover, unmatched with an integer multiple of 19 kHz. By performing stereo modulation processing by digital processing by the digital signal processor, the necessity of generating the signal of an integer multiple of 19 kHz is eliminated, and this enables the frequency condition required for the usable crystal resonator to be further alleviated, so that the degree of freedom in selecting component parts can be improved.

Further, the crystal resonator preferably has a natural vibration frequency of 32.768 kHz. As a result, the crystal resonator commercially available at a low cost generally used for watches and clocks can be used, and this can reduce the cost of components.

Further, the crystal resonator preferably has a natural vibration frequency matching the frequency allocation interval of the FM broadcast wave or an integer fraction of the frequency allocation interval. Alternatively, the crystal resonator preferably has a natural vibration frequency matching the frequency multiplied by the dividing ratio L of the third frequency divider for the frequency allocation interval of the FM broadcast wave or an integer fraction of the frequency allocation interval. As a result, an FM modulation signal having no frequency error for the frequency receivable by the FM receiver can be generated and transmitted, and the receiving quality at the time of receiving the FM modulation signal by the FM receiver can be improved.

Further, the digital signal processor preferably performs an FM modulation operation for a stereo composite signal obtained by a stereo modulation operation and an IQ modulation operation for extracting an I component and a Q component of the signal after the FM modulation operation. Specifically, the carrier wave generating circuit generates two types of the carrier waves mutually different 90 degrees in phase, and preferably further includes the transmitting circuit which has two mixers, one of which is for mixing the signal corresponding to the I component extracted by the digital signal processor and one of the carrier waves generated by the carrier wave generating circuit, and the other mixer is for mixing the Q component extracted by the digital signal processor and the other of the carrier waves generated by the carrier wave generating circuit separately, an adder for adding two types of the mixed signals obtained by these two mixers; and an amplifier for amplifying signal outputted from the adder and transmitting it via an antenna. By adopting the IQ modulation system, an image included in the FM transmitting signal can be reduced.

The second PLL circuit preferably has an oscillator in which an oscillation frequency is changed according to the amplitude of the stereo composite signal obtained by the stereo modulation operation by the digital signal processor. By adopting a so-called direct modulation system for variably changing the carrier wave frequency, the FM modulation signal can be transmitted by a simple configuration.

In place of the oscillator connected with the crystal resonator, an external circuit may be connected, and in place of the output signal of the oscillator connected with the crystal resonator, the signal supplied from the external circuit may be used. When another device such as FM receiver and the FM transmitter is formed as one chip component, by using a signal generated by a part of another device (external circuit) such as the FM receiver, the crystal resonator and the oscillator for the exclusive use of the FM transmitter can be omitted, and this can simplify the configuration.

### BRIEF DESCRIPTION OF THE DRAWINGS

FIG. 1 is a diagram showing the configuration of an FM transmitter of one embodiment;

FIG. 2 is a diagram sowing the detailed configuration of an analog front end;

FIG. 3 is a diagram showing an operation timing of three frequency dividers;

FIG. 4 is a diagram showing the detailed configuration of a DSP;

FIG. 5 is a diagram showing a modified example of the FM transmitter variably changing the resonance frequency of a resonance circuit included in a voltage controlled oscillator and performing FM modulation processing; and

FIG. 6 is a diagram showing the detailed configuration of the DSP included in the FM transmitter shown in FIG. 5.

### DESCRIPTION OF SYMBOLS

10 Analog front end (analog FE)
20 DSP (Digital Signal Processor)
30, 32 Digital-analog converter (D/A)
40, 42 Mixers
44 Adder
46 Amplifier
48 Antenna
50 Clock generating circuit
60 Frequency synthesizer
70 Crystal resonator
72 Oscillator (OSC)
78, 80, 82, 84 Frequency dividers
90 Control section
92 Operating section
94 Display section
200 Low pass filter (LPF)
202 Digital audio processing section
204 Multiplexer (MUX)
206 Pre-emphasis processing section
210 Stereo composite signal generating section
230 RDS data encoder
232 Adding section
240 Interpolation processing section
242 FM/IQ modulation processing section
246 Frequency shift processing section

### BEST MODE FOR CARRYING OUT THE INVENTION

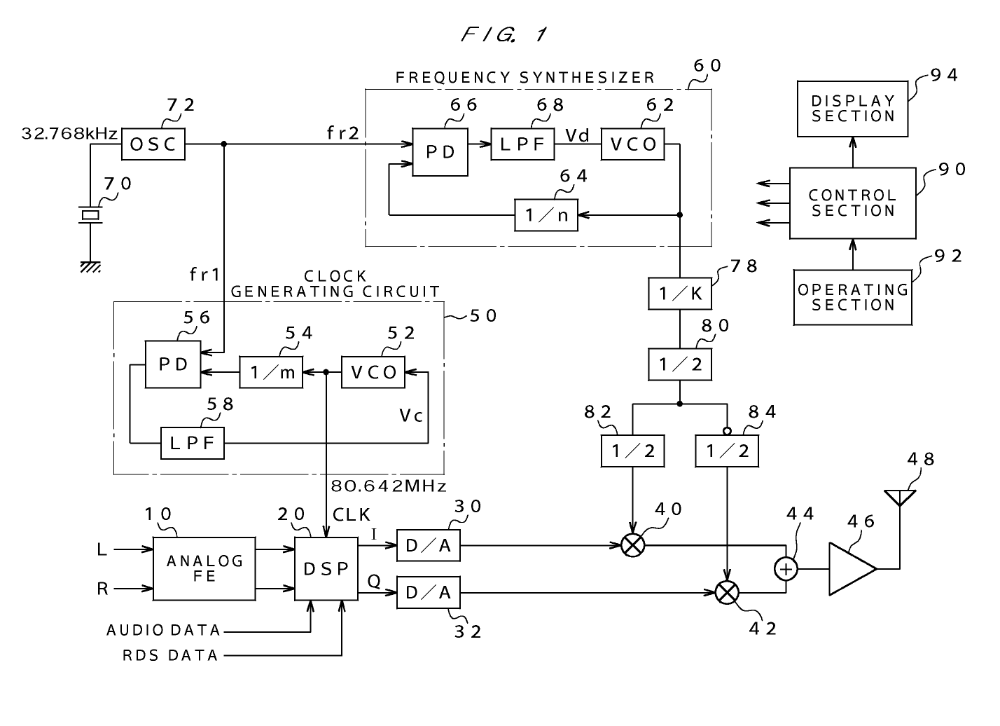

Hereinafter, an FM transmitter of one embodiment applying the present invention will be described in detail. FIG. 1 is a diagram showing the configuration of the FM transmitter of one embodiment. As shown in FIG. 1, the FM transistor of the present embodiment includes an analog front end (analog FE) 10, a DSP (digital signal processor) 20, digital-analog converters (D/A) 30 and 32, a mixers 40 and 42, an adder 44, an amplifier 46, an antenna 48, a clock generating circuit 50, a frequency synthesizer 60, a crystal resonator 70, an oscillator (OSC) 72, frequency dividers 78, 80, 82, and 84, a control section 90, an operating section 92, and a display section 94.

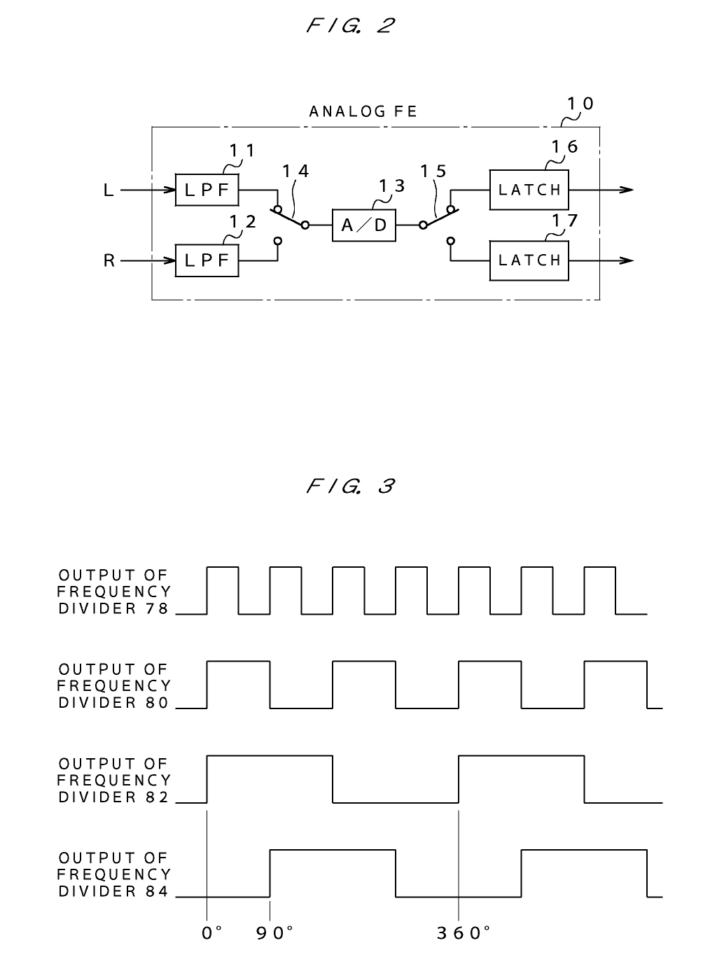

The analog front end 10 is inputted with an analog stereo signal made of a L signal and a R signal, and this signal is converted to L data and R data as digital stereo data. FIG. 2 is a diagram showing a detailed configuration of the analog front end 10. As shown in FIG. 2, the analog front end 10 includes low pass filters (LPF) 11 and 12, an analog-digital converter (A/D) 13, switches 14 and 15, and latches 16 and 17. The analog L signal, after passing through the low pass filter 11, is inputted to the analog-digital converter 13 through the switch 14. Likewise, the analog R signal, after passing through the low pass filter 12, is inputted to the analog-digital converter 13 through the switch 14. The analog-digital converter 13 samples each of the inputted L signal and R signal by a predetermined sampling frequency fs, thereby to generate digital L data and R data. The L data generated by the analog-digital converter 13 is held in the latch 16 through the switch 15. The R data generated by the analog-digital converter 13 is held in the latch 17 through the switch 15. The two switches 14 and 15 are for changing over the input system and output system of the analog-digital converter 13 synchronously, and changes over the connecting destination of the analog-digital converter 13 by a frequency 2 fs two times the sampling frequency fs. When the low pass filter 11 inputted with the L signal by the switch 14 and the analog-digital converter 13 are connected, the analog-digital converter 13 and the latch 16 for holding the L data are connected by the switch 15. On the other hand, when the low pass filter 12 inputted with the R signal and the analog-digital converter 13 are connected by the switch 14, the analog-digital converter 13 and the latch 17 for holding the R data are connected by the switch 15. From the analog front end 10, the L data and the R data held in the latches 16 and 17 respectively are outputted toward the DSP 20 of the next stage.

While, in the analog front end 10, the analog-digital conversion processing for the L signal and the R signal has been performed by using only one analog-digital converter 13, two analog-digital converters are provided for these two types of signals, and the analog-digital conversion processing may be performed separately.

The DSP 20, based on the L data and the R data outputted from the analog front end 10, performs stereo modulation processing, FM modulation processing, and IQ modulation processing by the digital processing. The DSP 20 is inputted with audio data and RDS data, and with these data as a target, the above described various processings can be also performed. From the DSP 20, I data and Q data after subjected to the IQ modulation are outputted. The detail of the DSP 20 will be described later.

The digital-analog converter 30 converts the I data outputted from the DSP 20 to the analog I signal. The digital-analog converter 32 converts the Q data outputted from the DSP 20 to the analog Q signal. The mixer 40 mixes the I signal outputted from one digital-analog converter 30 and a predetermined local oscillation signal (hereinafter referred to as a first local oscillation signal) to output. The mixer 42 mixes the Q signal outputted from the other digital-analog converter 32 and a local oscillation signal (hereinafter referred to as a second local oscillation signal) different 90 degrees in phase from the first local oscillation signal to output. The adder 44 synthesizes the signals outputted from the two mixers 40 and 42 to output. The output (FM modulation signal) of the adder 44, after being power-amplified by an amplifier 46, is transmitted from the antenna 48.

The clock generating circuit 50 generates an operation clock signal CLK necessary for the digital processing of the DSP 20. For an example, the circuit is inputted with a reference frequency signal fr1 of 32.768 kHz, and generates a clock signal CLK synchronizing with this reference frequency signal and having a frequency (80.642 kHz) that is 2461 times the frequency of the reference frequency signal. Hence, the clock generating circuit 50 includes a voltage controlled oscillator (VCO) 52, a frequency divider (1/m) 54, a phase comparator (PD) 56, and a low pass filter (LPF) 58. The voltage controlled oscillator 52 performs the oscillation operation of the frequency corresponding to the control voltage Vc. The frequency divider 54 divides the output signal of the voltage controlled oscillator 52 by a fixed dividing ratio m (=2461) to output. The phase comparator 56 performs a phase comparison of the frequency dividing signal outputted from the frequency divider 54 with the reference frequency signal fr1, and outputs a pulse signal having an advance or a delay corresponding to the phase difference. The low pass filter 58 smoothes the pulse signal outputted from the phase comparator 56 and generates a control voltage Vc which is supplied to the voltage controlled oscillator 52. In this manner, the clock generating circuit 50 has a PLL configuration (first PLL circuit), and generates a clock signal CLK having a frequency (80.642 MHz) that is 2461 times the frequency of the reference frequency signal fr1 to input into the DSP 20.

The frequency synthesizer 60 generates an oscillation signal necessary for generating the first and second local oscillation signals to be inputted to the mixers 40 and 42. For an example, the synthesizer is inputted with the reference frequency signal fr2 of 32.768 kHz, and the signal of the frequency synchronized with this reference frequency signal and n times this frequency is generated. Hence, the frequency synthesizer 60 includes a voltage controlled oscillator (VCO) 62, a variable frequency divider (1/n) 64, a phase comparator (PD) 66, and a low pass filter (LPF) 68. The voltage controlled oscillator 62 performs the oscillation operation of the frequency corresponding to the control voltage Vd. The variable frequency divider 64 divides and outputs the output signal of the voltage controlled oscillator 62 by a variable dividing ratio n. The phase comparator 66 performs a phase comparison of the frequency divided signal outputted from the variable frequency divider 64 with the reference frequency signal fr2, and outputs a pulse signal of the duty corresponding to the phase difference. The low pass filter 68 smoothes the pulse signal outputted from the phase comparator 66 to generate a control voltage Vd which is supplied to the voltage controlled oscillator 62. In this manner, the frequency synthesizer 60 has a PLL configuration (second PLL circuit), and generates a signal having a frequency n times the frequency of the reference frequency signal fr2. The dividing ratio n of the variable frequency divider 64 is set by the control section 90.

The oscillator 72 is connected with the crystal resonator 70, and is oscillated by the natural vibration frequency of the crystal resonator 70. In the present embodiment, the crystal resonator 70 has the natural vibration frequency lower than 38 kHz. Specifically, the crystal resonator 70 easily available and low in price and having the natural vibration frequency of 32.768 kHz is used. The oscillation signal of 32.768 kHz outputted from the oscillator 72 is inputted directly to the frequency synthesizer 60 as the reference frequency signal fr2, and at the same time, is inputted to the clock generating circuit 50 as the reference frequency signal fr1.

The frequency divider 78 has the dividing ratio limited to K (K is an integer above 1 or more), and divides the output signal of the voltage controlled oscillator 62 included in the frequency synthesizer 60 by the dividing ratio K to output. In the present embodiment, to simplify the explanation, the frequency diving ratio k is assumed to be set to 1. The three frequency dividers 80, 82, and 84 have each dividing ratio set to 2, and generate a signal having one fourth of the frequency for the output signal of the frequency divider 78 as a first local oscillation signal, and at the same time, generate a signal having the same frequency as the first local oscillation signal and different 90 degrees only in phase as a second local oscillation signal. The frequency divider 80 is used for waveform shaping, and the frequency dividers 82 and 84 are used for generating the first and second local oscillation signals different 90 degrees in phase. The frequency divider 80 is for allowing the signal of 50% in duty ratio to be reliably obtained by the frequency dividers 82 and 84. If the duty ratio of the output signals of the frequency dividers 82 and 84 is not 50%, the effect of eliminating the image is remarkably deteriorated, and this is prevented by using the frequency divider 80.

FIG. 3 is a diagram showing operation timing of the frequency dividers 80, 82, and 84. As shown in FIG. 3, the frequency divider 80 divides by 2 the output signal of the frequency divider 78 shown in [the output of the frequency divider 78] to output. The frequency divider 82 operates in synchronizing with a rise timing of the output signal of the frequency divider 80, and divides by 2 the output signal to output. On the other hand, the frequency divider 84 operates in synchronizing with a falling timing of the output signal of the frequency divider 80, and divides by 2 the output signal to output. In this manner, the first and second local oscillation signals mutually different 90 degrees in phase with the frequency being ¼ of the output signal of the frequency divider 78 are generated.

The control section 90 controls the FM transmitter overall. For examples, the control section 90 sets a dividing ratio of the variable frequency divider 64 included in the frequency synthesizer 60, and decides the transmission frequency of the FM modulation signal. The operating section 92 includes various types of switches operated by a user. For examples, such as a power supply switch, an up-key and a down-key for instructing the changeover of the transmission frequency, and a selection key for selecting and instructing a target resource to be transmitted (instructing as to which of analog audio signal or digital audio data is to be transmitted) are included. The display section 94 displays the transmission frequency, the operation content of the operating section 92, the remaining battery level, and the like.

In the present embodiment, each function of all the components except for the crystal resonator 70, the antenna 48, the operating section 92, and the display section 94 is integrally formed on a semiconductor substrate by using the semiconductor process. By integrally forming each function of all the components except for a part of components such as the crystal resonator 70 as one chip component by the semiconductor process, the miniaturization of the FM transmitter, easiness of the manufacture, the reduction of the power consumption, and the like becomes possible. Particularly, by adopting a CMOS process as the semiconductor process, the effect of these features become remarkable.

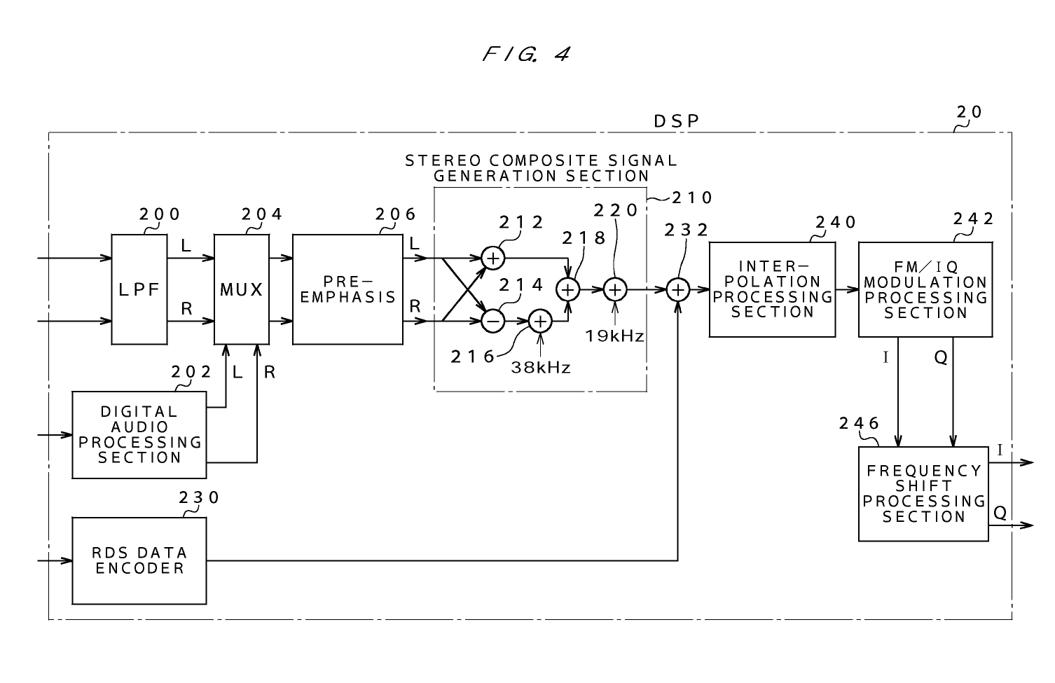

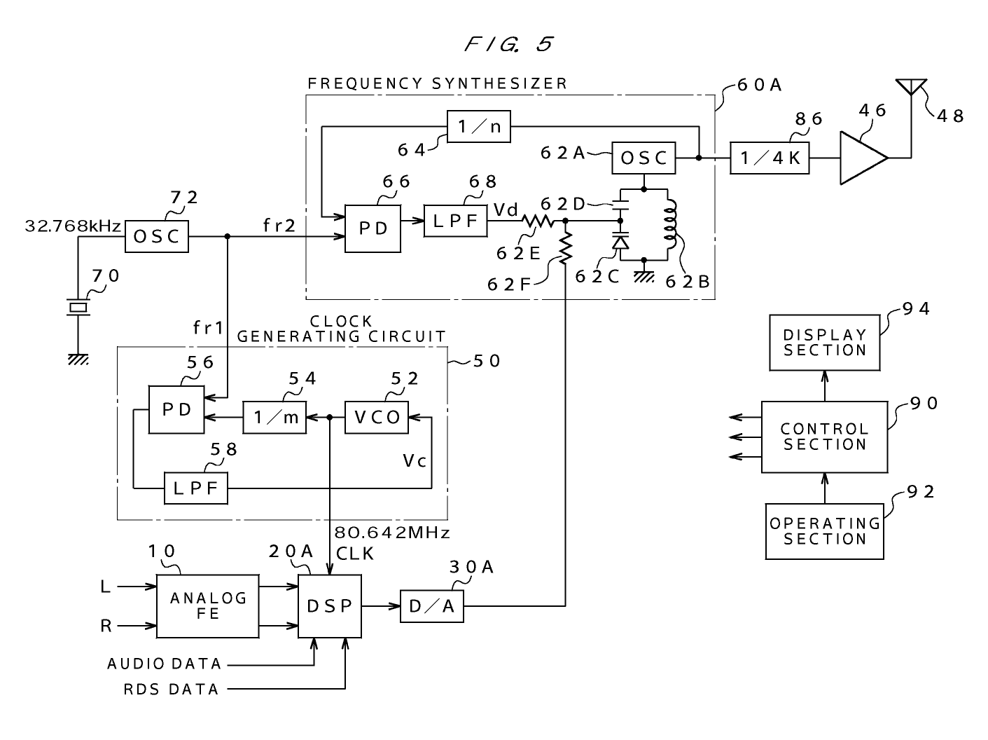

Next, the detail of the DSP 20 will be described. FIG. 4 is a diagram showing the detailed configuration of the DSP 20. As shown in FIG. 4, the DSP 20 includes a low pass filter (LPF) 200, a digital audio processing section 202, a multiplexer (MUX) 204, a pre-emphasis processing section 206, a stereo composite signal generating section 210, a RDS (Radio Data System) data encoder 230, an adding section 232, an interpolation processing section 240, an FM/IQ modulation processing section 242, and a frequency shift processing section 246. These functions of the respective configurations are realized by the digital processing performed by the DSP 20.

The low pass filter 200 performs band limitation for the prevention of an excess modulation, and eliminates a high band component included in each of the L data and the R data. The digital audio processing section 202, when inputted with the digital audio data of the predetermined format, extracts the L data and the R data included in this digital audio data, and performs the conversion of a sampling rate when the sampling rate of these L data and R data is different from the predetermined rate of the present embodiment. The multiplexer 204 is inputted with the L data and the R data outputted from the low pass filter 200 and with the L data and the R data outputted from the digital audio processing section 202, and selects and outputs either of the L data and the R data from the low pass filter 200 and the L data and the R data from the digital audio processing section 202. Whichever data is selected is decided by the control section 90 depending on the operation state instructed through the selection key of the operating section 92. The pre-emphasis processing section 206 is used for emphasizing a modulation degree of a high band frequency component.

The stereo composite signal generating section 210 generates a stereo composite signal by performing stereo modulation, and includes adding sections 212, 216, 218, and 220 and a subtracting section 214. By the adding section 212, the L data and the R data are added thereby to generate a (L+R) component. By the subtracting section 214, the R data is subtracted from the L data, thereby to generate a (L−R) component. The adding section 216 adds a sub-carrier signal of 38 kHz to the (L−R) component generated by the subtracting section 214. The adding section 218 generates a signal including the (L+R) component, the (L−R) component, and the sub-carrier signal by further adding up the adding results by the respective adding sections 212 and 216. This signal is added with the pilot signal by the adding section 220, thereby to generate a stereo composite signal, and this signal is outputted from the stereo composite signal generating section 210.

The RDS data encoder 230 performs a predetermined encode processing for the RDS character data and the like, thereby to generate the RDS data. The adding section 232 adds the RDS outputted from the RDS data encoder 230 to the stereo composite signal outputted from the stereo composite signal generating section 210. By this adding processing, the stereo composite signal superposed with the RDS data on a predetermined frequency band (vicinity to 57 kHz) is generated.

The interpolation processing section 240 performs interpolation processing to increase the number of data for the stereo composite signal to be inputted. For an example, fifty fold over sampling processing for allowing 49 pieces of data to be generated by the interpolation processing between two pieces of data sequentially inputted is executed. The FM/IQ modulation processing section 242 performs the FM modulation processing for the stereo composite signal after subjected to the interpolation processing, and at the same time, extracts the I component and the Q component of the data after the modulation. A real part (cos component) is the I component, and an imaginary part (sin component) is the Q component when the data after the modulation is expressed by a complex number.

The frequency shift processing section 246 performs a frequency shift (frequency conversion) for the I data and the Q data outputted from the FM/IQ modulation processing section 242. This frequency shift processing is for the purpose of preventing the sneaking of signals in the mixers 40 and 42 provided at the subsequent stage of the DSP 20. From the FM/IQ modulation processing section 242, a data of frequency modulated in the base band area is outputted. Assuming that this data is directly inputted to the mixers 40 and 42, the mixers 40 and 42 output an FM modulated signal having the same frequency as that of the first and second local oscillation signals outputted from the frequency dividers 82 and 84, respectively. Consequently, when a part of the first and second local oscillation signals sneaks into the output terminal side of the mixers 40 and 42, that is, a so-called carrier leak occurs, this sneaked first and second local oscillation signals are included in the band of the transmission signal, thereby causing a disadvantage of deteriorating the quality of the transmission signal. In the present embodiment, to avoid such a disadvantage, the processing to increase the frequency for the data having the frequency of the base band area is performed by the frequency shift processing section 246. Assuming that the shifted frequency is taken as an offset frequency f_{offset}, and the frequency of the first and the second local oscillation signals is taken as f_{LO}, the frequency fo of the output signals of the mixers 40 and 42 is (f_{LO}−f_{offset}) or (f_{LO}+f_{offset}), and hence, by setting the offset frequency f_{offset} to an appropriate value, the carrier leak in which the local oscillation signal leaks inside the band of the transmission signal outputted from the mixers 40 and 42 can be prevented.

The frequency synthesizer 60 and the frequency dividers 78, 80, 82, and 84 correspond to the carrier wave generating circuit, the frequency divider 54 corresponds to the first frequency divider, the variable frequency divider 64 corresponds to the second frequency divider, the frequency dividers 78, 80, 82, and 84 correspond to the third frequency divider, the mixers 40 and 42, the adder 44, and the amplifier 46 correspond to the transmission circuit, respectively.

The features of the FM transmitter of the present embodiment can be cited as follows.

(1) By using the clock generating circuit 50, a clock signal of high frequency (80.642 MHz in the example shown in FIG. 1) is generated, and the stereo modulation processing is performed by the digital processing by means of the DSP 20, it can be eliminated the necessity of generating the signal of 38 kHz as a sub-carrier or the signal of 19 kHz as a pilot signal. Hence, a degree of freedom in selecting components (crystal resonator) can be improved.

(2) The output of the oscillator 72 is inputted to the frequency synthesizer 60 as the reference frequency signal fr2 without dividing the same, and this enables the configuration to be simplified as compared with the case where the frequency divider is interposed between the oscillator and the synthesizer.

(3) Since the IQ modulation system is used, an image included in the FM transmission signal can be reduced.

(4) Since the crystal resonator 70 having the natural vibration frequency of 32.768 kHz is commercially available at a low cost for generally used for watches and clocks, it can be easily obtained, which makes it possible to reduce the component cost.

(5) Since the first and second local oscillation signals are generated by dividing by L (=4K) the output signals of the frequency synthesizer 60 by using the frequency dividers 78, 80, 82, and 84, it is possible to perform the changeover of the oscillation frequency of the frequency synthesizer 60 by the frequency interval 4K times 100 kHz which is the frequency allocation interval of the FM broadcast wave. Hence, even when the crystal resonator of 32.768 kHz unmatched with this frequency allocation interval or an integer fraction of this interval is used, an error between the desired frequency (frequency receivable by the FM receiver) and the actual frequency of the FM transmission signal can be reduced. For an example, when considering the case of K=1, the frequency half of 32.768 kHz becomes the maximum error, but when the output signal of the frequency synthesizer 60 is let pass through the frequency divider 80 and the like, this error can be reduced to ¼ (4.096 kHz). When the band of the FM modulation signal is taken as 150 kHz, this error of 4.096 kHz can be considered such as substantially negligible.

Meanwhile, as a reference frequency signal of the PLL frequency synthesizer, in general, the frequency of an integer fraction of the frequency allocation interval of the FM broadcast wave (100 kHz in the case of Japan) is selected. However, when the reference frequency signal of not an integer fraction of the frequency allocation interval of the FM broadcast wave is used similarly to the present embodiment, a technique is generally adopted in which the frequency is decreased as much as possible by using the frequency divider so that a difference between the frequency of the actual output signal of the PLL frequency synthesizer and the frequency of the signal desired to be transmitted is reduced.

However, when the frequency of the reference frequency signal is lowered, a loop gain of the PLL circuit making up the frequency synthesizer is reduced, and this deteriorates a CN ratio (a ratio between a carrier level and a noise) in the vicinity of the carrier wave frequency of the FM broadcast wave, thereby causing a disadvantage of the lock time of the PLL circuit becoming long. Further, a time constant of the low pass filter included the PLL circuit becomes great, and this makes it difficult to form all the components of the frequency synthesizer on the semiconductor substrate. In contrast to this, similarly to the present embodiment, when the output signal of the frequency synthesizer 60 is divided, the various disadvantages can be avoided, and at the same time, it is possible to reduce the difference (error of the oscillation frequency) between the frequency of the local oscillation signal generated by using the frequency synthesizer 60 and the frequency of the signal desired to be transmitted.

Describing the error of the oscillation frequency by means of a specific numerical value, it is as follows. Assume that the frequency of the reference frequency signal fr2 inputted to the frequency synthesizer 60 from the oscillator 72 is taken as Fr (=32.768 kHz). Further, assuming that the oscillation frequency of the voltage controlled oscillator 62 included in the frequency synthesizer 60 is taken as F_{OSC} and the frequency of the actual FM modulation signal transmitted from the amplifier 46 through the antenna 48 is taken as Fₜₓ, the following formula is established.

Fₜₓ=Fᵣ×n/(4K),

where n is a dividing ratio of the variable frequency divider 64, and 4K is a dividing ratio of all the frequency dividers 78, 80, 82, and 84.

Supposing that the frequency dividers 78, 80, 82, and 84 are not available (where 4K=1), to obtain Fₜₓ=90.00 MHz, it is necessary to set n=Fₜₓ/Fᵣ=2746.582. Since the actual n is an integer value, when decimal fractions are rounded, n=2747. In this case, 0.418×32.768 kHz=13.697 kHz of the fractional figure (0.418) is a frequency error of the FM modulation signal desired to be transmitted. In contrast to this, when the frequency dividers 78, 80, 82, and 84 are included, assuming that K=1, n=4K×Fₜₓ/Fᵣ=10986.33. When decimal fractions are rounded, n=10986. In this case, 2.70 kHz of the fractional figure (0.33) is the frequency error of the FM modulation signal desired to be transmitted. In this manner, by inserting the frequency dividers 78, 80, 82, and 84 into the subsequent stage of the frequency synthesizer 60, the error of the transmission frequency can be reduced.

It is to be understood that the present invention is not limited to the above described embodiment, but various modifications can be performed within the spirit and the scope of the present invention. For an example, in the above described embodiment, though the FM modulation processing and the IO modulation processing have been performed in the DSP 20, in the DSP, the only generation of the stereo complex signal is performed, and the FM modulation processing may be performed in the configuration arranged at a rear stage of the DSP.

FIG. 5 is a diagram showing a modification example of the FM transmitter performing the FM modulation processing by making the resonance frequency of a resonance circuit included in the voltage controlled oscillator variable. The FM transmitter shown in FIG. 5 includes the analog front end 10, a DSP 20A, a digital-analog converter 30A, the amplifier 46, the antenna 48, the clock generating circuit 50, a frequency synthesizer 60A, the crystal resonator 70, the oscillator (OSC) 72, the frequency divider 86, the control section 90, the operating section 92, and the display section 94. In this FM transmitter, the configuration basically performing the same operation as each configuration of the FM transmitter shown in FIG. 1 is attached with the same reference numeral, and the description will be made below by focusing an attention on the configuration different in the basic operation.

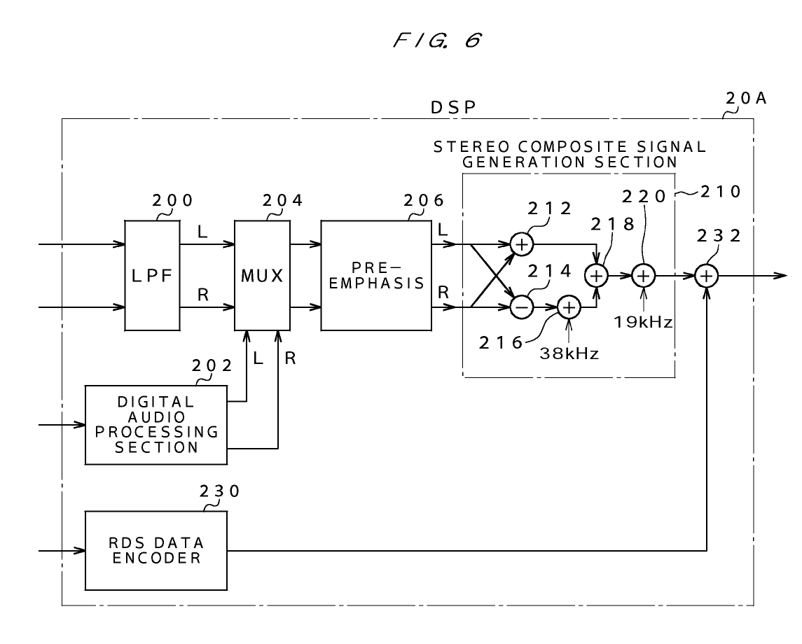

FIG. 6 is a diagram showing the detailed configuration of the DSP 20A included in the FM transmitter shown in FIG. 5. The DSP 20A performs stereo modulation processing based on the L data and R data outputted from the analog front end 10. As shown in FIG. 6, the DSP 20A includes a low pass filter (LPF) 200, a digital audio processing section 202, a multiplexer (MUX) 204, a pre-emphasis processing section 206, a stereo composite signal generating section 210, and an adding section 232. These functions of the respective configurations are realized by the digital processing performed by the DSP 20A. The DSP 20A, as against the DSP 20 shown in FIG. 4, has a configuration omitting the interpolation processing section 240, the FM/IQ modulation processing section 242, and the frequency shift processing section 246. That is, in the DSP 20A, the stereo composite signal outputted from the stereo composite signal generating section 210 is directly outputted. The stereo composite signal (digital data) outputted from the DSP 20A is converted to an analog signal by the digital-analog converter 30A, and is inputted to the frequency synthesizer 60A.

The frequency synthesizer 60A is inputted with the reference frequency signal fr2, and generates a signal having the frequency synchronizing with the reference frequency signal and of n times the frequency of the reference frequency. Hence, the frequency synthesizer 60A includes an oscillator (OSC) 62A, an inductor 62B, a variable capacitance diode 62C, a capacitor 62D, resistors 62E and 62F, the variable frequency divider (1/n) 64, the phase comparator (PD) 66, and the low pass filter (LPF) 68. The oscillator (OSC) 62A configures a voltage controlled oscillator together with a parallel resonance circuit made of the inductor 62B, the variable capacitance diode 62C, and the capacitor 62D. The output terminal of the low pass filter 68 is connected to a connecting point with the variable capacitance diode 62C and the capacitor 62D through the resistor 62E. According to the control voltage Vd outputted from the low pass filter 68, the resonance frequency of the parallel resonance circuit is decided, and by this frequency, the oscillator 62A is oscillated. The connecting point with the variable capacitance diode 62C and the capacitor 62D is connected with the output terminal of the digital-analog converter 30A through the resistor 62F. Since the stereo composite signal is outputted from the digital-analog converter 30A, when the potential of the connecting point of the variable capacitance diode 62C and the capacitor 62D changes according to the amplitude of the stereo composite signal, the oscillation frequency of the oscillator 62A is also varied. In this manner, the FM modulation operation for the stereo composite signal is performed.

The frequency divider 86 divides the oscillation signal of the oscillator 62A included in the frequency synthesizer 60A by a dividing ratio 4K=L, and output the same. The output signal (FM modulation signal) of the frequency divider 86 is power-amplified by the amplifier 46, and after that, it is transmitted from the antenna 48.

In this manner, the generation of the stereo composite signal is performed by the DSP 20A, and the oscillation frequency of the oscillator 62A included in the frequency synthesizer 60A may be changed according to the amplitude of the stereo composite signal, thereby to perform the FM modulation. By adopting a so-called direct modulation system for variably changing the carrier wave frequency, the FM modulation signal can be transmitted by a simple configuration.

In the above described embodiment, though the crystal resonator 70 having the natural vibration frequency of 32.768 kHz has been used, the natural vibration frequency of the crystal resonator 70 is considered to be variously modified depending on the reference frequency signals fr1 and fr2 or the relationship with the frequency allocation interval of the FM broadcast wave. In consideration of these modifications, the relationship of various frequencies in the applicable range of the present invention can be cited as follows.

(1) The Case where the Natural Vibration Frequency of the Crystal Resonator 70 does not Match the Frequency Allocation Interval of the FM Broadcast Wave or an Integer Fraction of this Frequency Allocation Interval

Although the frequency allocation interval of the FM broadcast wave is 100 kHz, when considering that the output side of the frequency synthesizer 60 is connected with the frequency dividers 78, 80, 82, and 84 whose entire dividing ratio is [4K], the interval of the oscillation frequency required for the frequency synthesizer 60 becomes (4K×100) kHz. Consequently, this means that, in the case of (1), the natural vibration frequency of the crystal resonator 70 does not match (4K×100 kHz) or does not match an integer fraction of (4K×100 kHz). For an example, in the case of K=1, the crystal resonator 70 having the natural vibration frequency unmatched with 400 kHz or an integer fraction of 400 kHz is used. The natural vibration frequency (32.768 kHz) of the crystal resonator 70 shown in FIG. 1 is applicable to the case of (1). In the configuration shown in FIG. 5, it is possible to omit the frequency divider 86, and in this case, 4K=1, and therefore the crystal resonator 70 having the natural vibration frequency unmatched with the value of 100 kHz or an integer fraction of 100 kHz is used.

Further, in the present embodiment, since the stereo modulation operation is performed by the digital process by the DSP 20, the signals of 19 kHz and 38 kHz are unnecessary as different as in the past, and as a condition of the natural vibration frequency of the crystal resonator 70, a condition of not matching the integer multiple of 19 kHz can be added. In other words, when the natural vibration frequency of the crystal resonator 70 is set (selected), the condition of the integer multiple of 19 kHz becomes unnecessary. As a result, the frequency condition required for the usable crystal resonator can be further alleviated, and a degree of freedom in selecting components can be improved.

(2) The Case where the Natural Vibration Frequency of the Crystal Resonator 70 Matches the Frequency Allocation Interval of the FM Broadcast Wave or an Integer Fraction of this Frequency Allocation Interval

In contrast to the case of (1), the natural vibration frequency of the crystal resonator 70 may be allowed to match (4K×100) kHz or an integer fraction of (4K×100) kHz. As a result, for the frequency receivable by the FM receiver, the FM modulation signal having no frequency error can be generated and transmitted, and the reception quality when receiving the FM modulation signal by the Fm receiver can be improved.

In the above described embodiment, though the oscillator 72 connected with the crystal resonator 70 has been used, in place of the crystal resonator 70 and the oscillator 72, an external circuit (not shown) may be connected, and the signal supplied from the external circuit may be inputted to the clock generating circuit 50 and the frequency synthesizer 60 as the reference frequency signals fr1 and fr2. When the FM transmitter and the FM receiver and the like are formed as one chip component or the like, the signal generated by a part (external circuit) of the FM receiver and the like is used, so that the crystal resonator 70 and the oscillator 72 for exclusive use of the FM transmitter can be omitted, and this can simplify the configuration.

### INDUSTRIAL APPLICABILITY

According to the present invention, the respective functions of all components except for the crystal resonator are formed as one chip component by the semiconductor process, so that the miniaturization of the FM transmitter, easiness of the manufacture, and the reduction of the power consumption becomes possible. Particularly, by adopting the CMOS process as the semiconductor process, the effect of these features becomes remarkable.

1. An FM transmitter, comprising:
an oscillator connected with a crystal resonator;
a clock generating circuit for generating a clock signal synchronized with an output signal of the oscillator;
a digital signal processor inputted with the clock signal generated by the clock generating circuit as an operation clock and performing a stereo modulation operation for stereo data by digital processing; and
a carrier wave generating circuit directly inputted with the output signal of the oscillator and generates a carrier wave of synchronizing with the output signal and having a frequency of an integer multiple of a frequency of the output signal;
wherein an FM modulation signal frequency-modulated by a stereo composite signal obtained by stereo modulating the carrier wave performed by the digital signal processor is transmitted.

2. The FM transmitter according to claim 1, wherein respective functions of the oscillator excepting for the crystal resonator, the clock generating circuit, the digital signal processor, and the carrier wave generating circuit are integrally formed on a semiconductor substrate by using a semiconductor process.

3. The FM transmitter according to claim 1, wherein the clock generating circuit is a first PLL circuit in which the output signal of the oscillator is inputted as a first reference frequency signal fr1, and
wherein, when a dividing ratio of a first frequency divider included in the first PLL circuit is taken as an integer m, the clock signal having a frequency m times the frequency of the first reference frequency signal fr1 is generated.

4. The FM transmitter according to claim 3, wherein the carrier wave generating circuit is a second PLL circuit in which the output signal of the oscillator is inputted as a second reference frequency signal fr2, and
wherein, when a dividing ratio of a second frequency divider included in the second PLL circuit is taken as an integer n, the carrier wave having a frequency n times the frequency of the second reference frequency signal fr2 is generated.

5. The FM transmitter according to claim 4, wherein the second PLL circuit is a frequency synthesizer variable in dividing ratio n of the second frequency divider, and
wherein a control section is further provided in which, by changing the dividing ratio n, the frequency of the output signal of the second PLL circuit is set variable at the frequency allocation interval of an FM broadcast wave or an integer fraction of the frequency allocation of interval.

6. The FM transmitter according to claim 4, wherein the carrier wave generating circuit outputs a signal, in which the signal generated by the second PLL circuit is divided by a third frequency divider of a dividing ratio L, as the carrier wave.

7. The FM transmitter according to claim 6, wherein the second PLL circuit is a frequency synthesizer variable in a dividing ratio n of the second frequency divider, and
wherein, by changing the dividing ratio n, a control section for variably setting the frequency of the output signal of the second PLL circuit at a frequency interval multiplied by a dividing ratio L of the third frequency divider for the frequency allocation interval of the FM broadcast wave or an integer fraction of the frequency allocation interval is further provided.

8. The FM transmitter according to claim 1, wherein the crystal resonator is an FM transmitter having a natural vibration frequency unmatched with the frequency allocation interval of the FM broadcast wave or an integer fraction of this frequency allocation interval.

9. The FM transmitter according to claim 1, wherein the crystal resonator is an FM transmitter having the natural vibration frequency unmatched with the frequency allocation interval of the FM broadcast wave or an integer fraction of this frequency allocation interval, and moreover, unmatched with an integer multiple of 19 kHz.

10. The FM transmitter according to claim 6, wherein the crystal resonator is an FM transmitter having the natural vibration frequency unmatched with the frequency multiplied by a dividing ratio L of the third frequency divider for the frequency allocation interval of the FM broadcast wave or an integer fraction of the frequency allocation interval, and moreover, unmatched with an integer multiple of 19 kHz.

11. The FM transmitter according to claim 8, wherein the crystal resonator is an FM transmitter having the natural vibration frequency of 32.768 kHz.

12. The FM transmitter according to claim 1, wherein the crystal resonator is an FM transmitter having the natural vibration frequency matching the frequency allocation interval of the FM broadcast wave or an integer fraction of the frequency allocation interval.

13. The FM transmitter according to claim 6, wherein the crystal resonator is an FM transmitter having the natural vibration frequency matching the frequency multiplied by a dividing ratio L of the third frequency divider for the frequency allocation interval of the FM broadcast wave or an integer fraction of the frequency allocation interval.

14. The FM transmitter according to claim 1, wherein the digital signal processor is an FM transmitter performing an FM modulation operation for the stereo composite signal obtained by the stereo modulation operation and an IQ modulation operation for extracting an I component and a Q component of the signal after the FM modulation.

15. The FM transmitter according to claim 14, wherein the carrier wave generating circuit generates two types of the carrier waves mutually different 90 degrees in phase, and further comprises the transmitting circuit which has two mixers for mixing either one of two types of signals corresponding to the I component and the Q component respectively extracted by the digital signal processor and either one of said two types of carrier waves generated by the carrier wave generating circuit separately, an adder for adding two types of the mixed signals obtained by these two mixers, and an amplifier for amplifying output signal from the adder and transmitting the output signal amplified via the antenna.

16. The FM transmitter according to claim 4, wherein the second PLL circuit is an FM transmitter having an oscillator to change in oscillation frequency according to an amplitude of the stereo composite signal obtained by the stereo modulation operation by the digital signal processor.

17. The FM transmitter according to claim 1, wherein, in place of the oscillator connected with the crystal resonator, an external circuit is connected, and in place of the output signal of the oscillator connected with the crystal resonator, a signal supplied from the external circuit is used.

18. The FM transmitter according to claim 2, wherein the semiconductor process is a CMOS process.

19. The FM transmitter according to claim 1, wherein the crystal resonator has the natural vibration frequency lower than 38 kHz.
